(19) United States
(12) Patent Application Publication
(10) Pub. No.: US 2017/0060135 A1
(43) Pub. Date: Mar. 2, 2017

(54) VEHICLE-LOCATION SYSTEM FOR AN AUTOMATED VEHICLE

(71) Applicant: DELPHI TECHNOLOGIES, INC., Troy, MI (US)

(72) Inventors: NATHAN A. PENDLETON, SAN JOSE, CA (US); MICHAEL H. LAUR, MISSION VIEJO, CA (US); JONATHAN L. WIESKAMP, SUNNYVALE, CA (US)

(21) Appl. No.: 14/838,762

(22) Filed: Aug. 28, 2015

(51) Int. Cl. G05D 1/02

(52) U.S. Cl. CPC G05D 1/0234; G05D 1/0242

(57) ABSTRACT

A system to determine a vehicle-location of an automated vehicle includes a light-source, a sensor, and a controller. The light-source is located at a light-location that is observable from a roadway. The light emitted by the light-source is modulated to broadcast the light-location of the light-source. The sensor is mounted on a vehicle. The sensor is operable to detect the light in order to receive the light-location and determine a direction of the light relative to the vehicle and/or the roadway. The controller is configured to determine a vehicle-location of the vehicle based on the direction and the light-location.

### TECHNICAL FIELD OF INVENTION

This disclosure generally relates to a system that determines a vehicle-location of an automated vehicle, and more particularly relates to a system receives a light-location of a light-source via modulation of the light, determines a direction of the light relative to the vehicle, and determines a vehicle-location of the vehicle based on the direction and the light-location.

### BACKGROUND OF INVENTION

It is known that automated-vehicles are operated at locations where signals from global positioning system (GPS) satellites are blocked. Urban canyons and multi-level parking structures are but two examples of such locations. Automated vehicles that rely heavily on GPS to maneuver may experience problems if GPS signals are unavailable.

### SUMMARY OF THE INVENTION

In accordance with one embodiment, a system to determine a vehicle-location of an automated vehicle is provided. The system includes a light-source, a sensor, and a controller. The light-source is located at a light-location that is observable from a roadway. The light emitted by the light-source is modulated to broadcast the light-location of the light-source. The sensor is mounted on a vehicle. The sensor is operable to detect the light in order to receive the light-location, and determine a direction of the light relative to the vehicle. The controller is configured to determine a vehicle-location of the vehicle based on the direction and the light-location.

Further features and advantages will appear more clearly on a reading of the following detailed description of the preferred embodiment, which is given by way of non-limiting examples only and with reference to the accompanying drawings.

### BRIEF DESCRIPTION OF DRAWINGS

The present invention will now be described, by way of example with reference to the accompanying drawings, in which:

FIG. 1 is a perspective view of a system for operating a vehicle on a roadway in accordance with one embodiment;

FIG. 2 is a diagram of the system of FIG. 1 in accordance with one embodiment; and

FIG. 3 is perspective view of a scenario encountered by the system of FIG. 1 in accordance with one embodiment.

### DETAILED DESCRIPTION

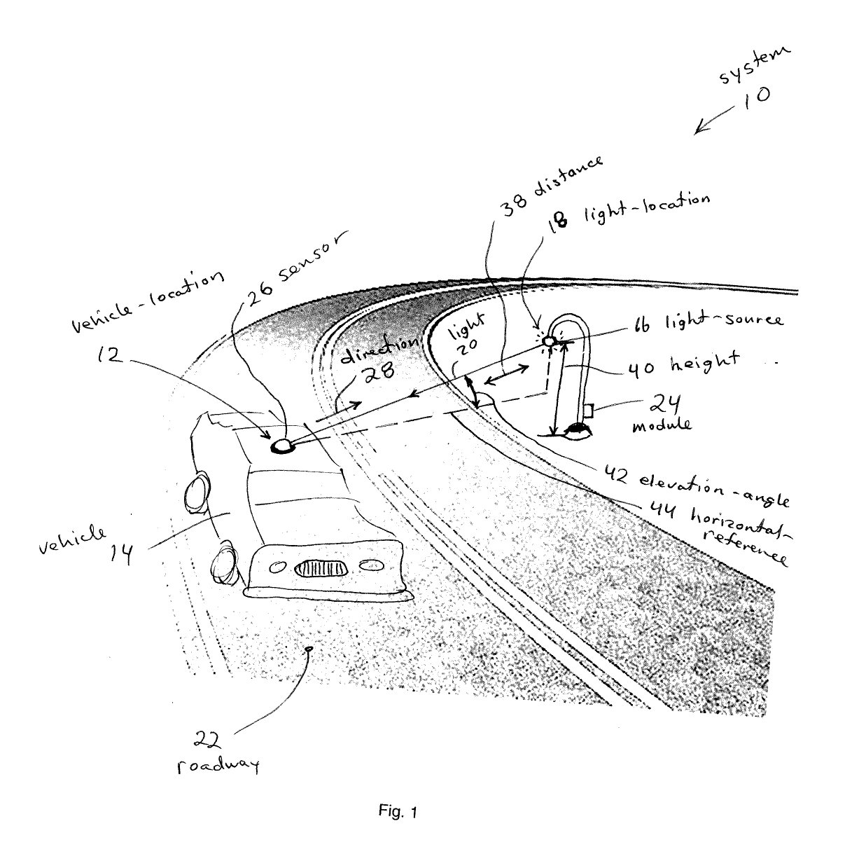

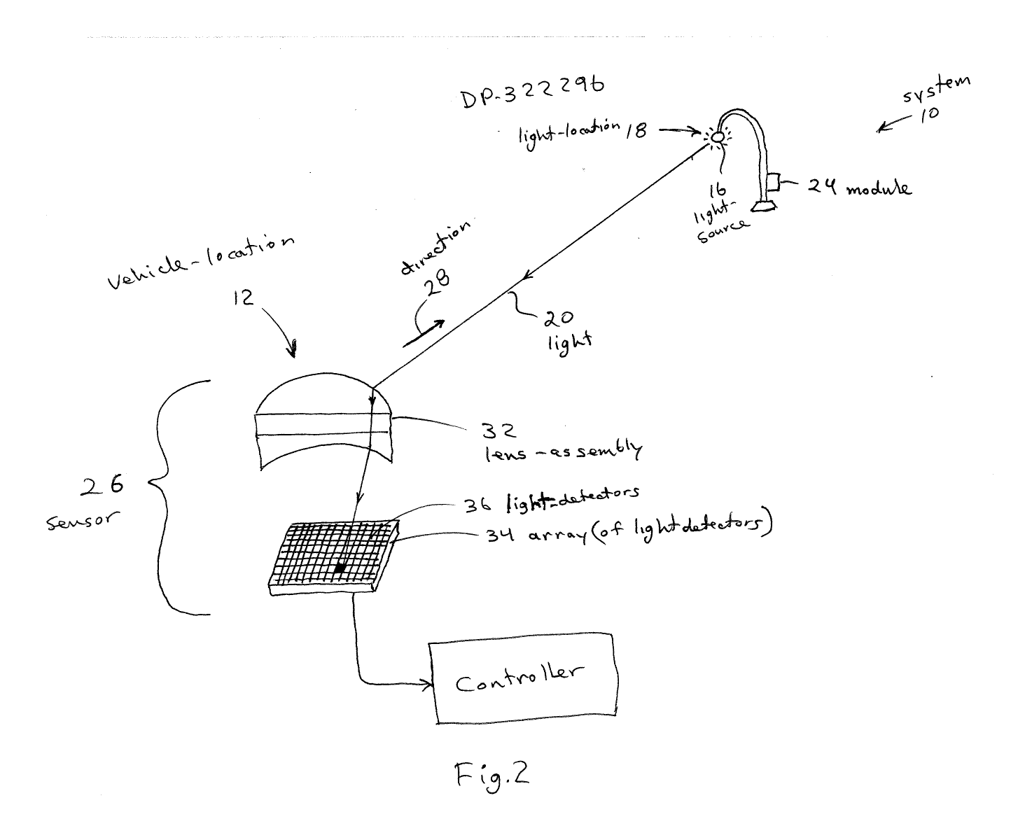

FIGS. 1 and 2 illustrate a non-limiting example of a system 10 useful to determine a vehicle-location 12 of a vehicle 14 when location signals from global positioning system satellites (GPS satellites) are blocked or otherwise unavailable. While the non-limiting examples presented herein are generally directed to a fully automated vehicle, i.e. an autonomous vehicle, aspects of the system 10 are useful to operators of manually driven vehicles that may be partially automated to provide, for example, steering or navigation assistance to the operator. The system 10 described herein overcomes the problems of global positioning system signals (GPS signals) being blocked by buildings, mountains, over-passes, and the like. While examples of these obstructions are not shown in FIG. 1, it is only to simplify the illustration.

The system 10 overcomes the problems of blocked GPS signals by first providing or including a light-source 16 located at a light-location 18 that is observable from a roadway 22 traveled by the vehicle 14. As used herein, the roadway 22 is not limited to actual roads with well-defined travel-lanes and boundaries, but includes any surface that the vehicle can negotiate. For example, the roadway 22 could be a multi-level parking facility or open field. Light 20 emitted by the light-source 16 is modulated in a manner effective to broadcast the light-location 18 of the light-source 16 via the light 20.

The light-location 18 may be specified by global positioning system coordinates (GPS coordinates) of the light-source 16. That is, the GPS coordinates that correspond to the light-location 18 may be encoded into the light 20 by modulating the intensity of the light 20. Alternatives to GPS coordinates are contemplated such as the location of the light-source 16 relative to the roadway 22, e.g. how far the light is from, for example, the center of the roadway 22. The light-location 18 may be pre-programmed into a module 24 that controls the operation of the light-source 16 so the light-location 18 is encoded into the light 20. Alternatively, the module 24 may communicate to an internet server (not shown) via a wireless network (e.g. Wi-Fi, cellular) to that the information included in the light-location can be readily updated if necessary.

The light 20 may advantageously be infrared-light and may be modulated using known modulation techniques such as those used by remote controls for entertainment devices such as a television. Infrared-light may be advantageous as it is not visible to human-beings so is not annoying or distracting. However, the light 20 could be in the visible spectrum, but is preferably modulated at a high enough frequency so that the modulation is not detectible by human eyes. Whether infrared or visible light, a variety of modulation techniques are known, and selecting which to use should include a consideration of the amount (e.g. number of bits) of information that is being communicated or broadcast by the light-source 16, and how quickly that information needs to be repeated.

In order to detect or receive the light-location 18 being broadcast by the light-source 16, the system 10 includes a sensor 26 mounted on the vehicle 14. The sensor 26 is configured or operable to detect the light 20 in a manner effective to receive the light-location 18. That is, the sensor 26 is able to discern the modulation of the light 20 so that the information that that makes up the light-location 18 can be extracted from the light 20. In order for the system 10 to determine the vehicle-location 12 given the light-location 18, the sensor 26 is also operable to determine a direction 28 of the light 20 relative to the vehicle 14 and/or the roadway 22. While a single instance of the sensor 26 is shown, an optional configuration with multiple instance of the sensor 26 is contemplated. For example, two or more sensors could be installed at various positions on the vehicle 14, and these multiple sensors may each determine a direction to the light-source 16 so known geometry methods can then be used to determine distance to the light-source 16, and likely a more precise location. In general, the sensor 26 is operable to determine the direction 28 from the vehicle 14 to the light-source 16 so that a relative-location of the vehicle 14 relative to the light-source 16 can be determined. Given the relative-location in combination with light-location 18 (e.g. GPS coordinates), and if necessary a digitized map of the roadway 22 (e.g. a GPS map), the vehicle-location 12 of the vehicle 14 relative to the roadway 22 can be determined. A digitized map may not be necessary if information about the roadway 22 such as shape (curved or straight, number of lanes, relative-locations of barriers, etc.) is also encoded into the light 20. Further details of how the relative location is determined are presented later in this disclosure.

In order to perform the data processing describe above, the system 10 includes a controller 30 configured to determine the vehicle-location 12 of the vehicle 14 based on the direction 28 and the light-location 18. The controller 30 may include a processor (not specifically shown) such as a microprocessor or other control circuitry such as analog and/or digital control circuitry including an application specific integrated circuit (ASIC) for processing data as should be evident to those in the art. The controller 30 may include memory (not specifically shown), including non-volatile memory, such as electrically erasable programmable read-only memory (EEPROM) for storing one or more routines, thresholds and captured data. The one or more routines may be executed by the processor to perform steps for determining when signals received by the controller 30 from the sensor 26 indicate the direction 28 to the light-source 16 and the light-location 18 encoded in the light 20 emitted by the light-source 16, as described herein.

Referring now to FIG. 2, a non-limiting example of one possible embodiment of the sensor 26 is described. The sensor 26 may include a lens-assembly 32 configured to direct light from three-hundred-sixty-degrees of angle (360°) relative to a horizontal plane that is generally parallel to the roadway 22, with a sufficient range of elevation-angle so the light 20 can be detected from the light-source 16 regardless of the direction 28. By way of example and not limitation, the lens-assembly 32 may be a commercially available hemispheric lens or hemispherical lens oriented to direct the light 20 onto an array 34 of light-detectors 36 (i.e.—photodetector array, photodiode array). Unlike a typical video imaging device that is generally used to capture images where all of the pixels are simultaneously operated, and images are captured a relatively low frame-rate (e.g. <1000 Hz), the array 34 is configured or operable so each of the light-detectors 36 is operable to detect modulation of the light 20 and output a signal indicative of the light-location 18. That is, a single light-detector or pixel of the array 34 can be monitored continuously or sampled at a sufficient rate (e.g. >1000 Hz) so that the modulation of the light 20 can be detected and the controller 30 can extract the light-location 18 and/or other information encoded into the light 20.

In order to determine the direction 28, the controller 30 is also configured to determine which of the light-detectors 36 is receiving the light 20. The system 10 may undergo a calibration process at the time of manufacture and/or at the time the sensor 26 is installed on the vehicle 14 so that the relationship between the direction 28 and which of the light-detectors 36 corresponds to a particular value of the direction 28 can be ‘learned’. As such, the controller 30 is configured to determine the direction 28 based on which of the light-detectors 36 is receiving the light 20. An advantage of the sensor 26 described herein is that multiple light-sources can be detected simultaneously given that the controller 30 is configured to select and simultaneously monitor multiple instances of the light-detectors 36. It is preferable that the system 10 be configured so that at least one light-source is always being detected, however this is not a requirement as the system 10 can be configured to guide the vehicle 14 using dead-reckoning techniques from one instance of the light-source 16 to the next instance.

As an alternative configuration of the sensor 26, the hemispherical lens could be replaced with a more typical lens in combination with a servo-controlled minor. The orientation of the mirror could be manipulated to scan the area about the vehicle 14 until an instance of the light-source 16 is detected, and then the mirror could be manipulated to track the light-source 16 as it is presumed that the vehicle is moving. The advantage of this configuration is that a lower resolution array could be used. However, the added cost necessary to manipulate the mirror may off-set the savings. Another alternative configuration uses a linear-array (single row) of light-detectors and a mirror assembly configured so the minor-assembly only needs to be rotated and not manipulated to change the vertical viewing direction of the sensor 26.

Depending on the type of information included in the light-location 18, it may be necessary to determine a distance 38 between the sensor 26 and the light-source 16. In one embodiment, the light-location 18 may include a height 40 of the light-source 16 above the roadway 22. The direction 28 includes an elevation-angle 42 of the direction 28 relative to a horizontal-reference 44 of the sensor 26. The controller 30 may be configured to determine the distance 38 from the sensor 26 to the light-source 16 based on the height 40 and the elevation-angle 42, using known geometry techniques and with prior or pre-programmed knowledge of the height of the sensor 26 above the roadway 22. If, for example, the light-location 18 includes GPS coordinates, then the vehicle-location 12 can be determined in terms of GPS coordinates, and the vehicle 14 may be steered according to a GPS map stored in the system 10 or the vehicle 14 even though a GPS signal from a GPS satellite is not received.

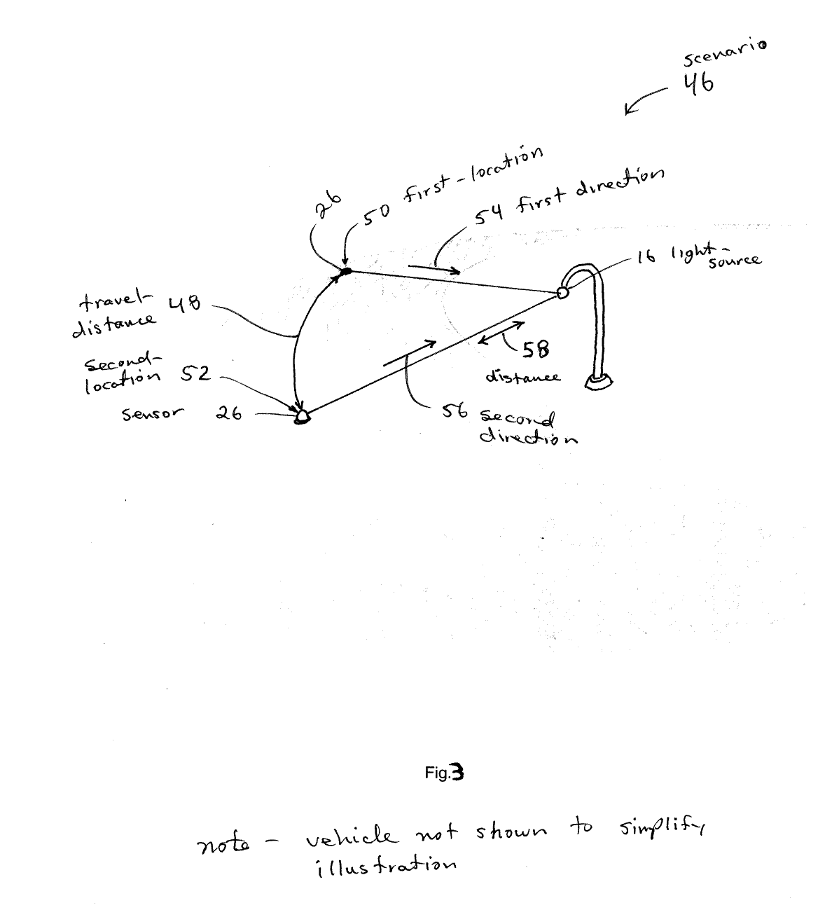

FIG. 3 illustrates a non-limiting example of a scenario 46 for determining the location of the sensor 26 relative to the light-source 16. It is noted that the sensor 26 is mounted on the vehicle 14, but the vehicle 14 is not illustrated in order to simplify the illustration. For the scenario 46, the vehicle 14 (not shown) is equipped to indicate to the controller 30 a travel-distance 48 between a first-location 50 and a second-location 52, which for this example corresponds to the vehicle-location 12 shown in FIG. 1. The travel-distance 48 may be determine using dead-reckoning and/or inertial guidance techniques, as will be recognized by those in the art. The controller 30 is configured to determine a first-direction 54 to the light-source 16 from the first-location 50 and a second-direction 56 to the light-source 16 from the second-location 52. Without considering height of various objects, i.e. only considering X-Y coordinates (e.g. latitude-longitude), the controller may be configured to determine a distance 58 (comparable to the distance 38 in FIG. 1) from the sensor 26 to the light-source 16 based on the travel-distance 48, the first-direction 54, and the second-direction 56 using know geometry techniques.

Accordingly, the system 10 to determine a vehicle-location of an automated vehicle, and a controller 30 for the system 10 are provided. The system 10 overcomes the problem of blocked or lost GPS satellite signals when GPS is the preferred means for navigating (e.g. steering) an automated vehicle. Light-sources emit modulated light, where the modulation incorporates information such as the location of a light-source into the light emitted. The detection of this information combined with a determination of distance and/or direction to the light-source allows the system 10 determine the location of a vehicle on a roadway without GPS satellite signals.

While this invention has been described in terms of the preferred embodiments thereof, it is not intended to be so limited, but rather only to the extent set forth in the claims that follow.

We claim:

1. A system to determine a vehicle-location of an automated vehicle, said system comprising:
a light-source located at a light-location that is observable from a roadway, wherein light emitted by the light-source is modulated to broadcast the light-location of the light-source;
a sensor mounted on a vehicle, said sensor operable to detect the light in order to receive the light-location and determine a direction of the light relative to the vehicle; and
a controller configured to determine a vehicle-location of the vehicle based on the direction and the light-location.

2. The system in accordance with claim 1, wherein the light is characterized as infrared-light.

3. The system in accordance with claim 1, wherein the light-location is specified by global positioning system coordinates (GPS coordinates) of the light-source.

4. The system in accordance with claim 1, wherein the sensor includes an array of light-detectors, each of the light-detectors is operable to detect modulation of the light and output a signal indicative of the light-location.

5. The system in accordance with claim 4, wherein the controller is configured to determine the direction based on which of the light-detectors is receiving the light.

6. The system in accordance with claim 1, wherein the light-location includes a height of the light-source above the roadway, the direction includes an elevation-angle, and the controller is configured to determine a distance from the sensor to the light-source based on the height and the elevation-angle.

7. The system in accordance with claim 1, wherein the vehicle is equipped to indicate to the controller a travel-distance between a first-location and a second-location, and the controller is configured to determine a first-direction to the light-source from the first-location and a second-direction to the light-source from the second-location, and the controller is configured to determine a distance from the sensor to the light-source based on the travel-distance, the first-direction, and the second-direction.

8. A vehicle-system to determine a vehicle-location of an automated vehicle, said vehicle-system comprising:
a sensor mounted on a vehicle, said sensor operable to detect light from a light-source located at a light-location that is observable by the sensor, wherein the light emitted by the light-source is modulated to broadcast the light-location of the light-source, said sensor operable to receive the light-location and determine a direction of the light relative to the vehicle; and
a controller configured to determine a vehicle-location of the vehicle based on the direction and the light-location.
